(19) United States
(12) Patent Application Publication
(10) Pub. No.: US 2012/0234466 A1
(43) Pub. Date: Sep. 20, 2012

(54) INSULATING GLASS PRODUCTION METHOD AND UNIT

(76) Inventors: Mario Balbi, Cuneo (IT); Oriano Bertoncello, San Martino Di Lupari (IT)

(21) Appl. No.: 13/403,503

(22) Filed: Feb. 23, 2012

(30) Foreign Application Priority Data
Feb. 23, 2011 (IT) TO2011A000151

(51) Int. Cl. B32B 37/14; B32B 37/12

(52) U.S. Cl. 156/109; 156/349

(57) ABSTRACT

Insulating glass is produced by forming an assembly having at least two facing glass sheets and at least one inner spacer frame separating the glass sheets, and by depositing a bead of sealant on an outer peripheral edge of the assembly; the sealant being deposited by keeping the assembly stationary in a vertical position, and moving a dispenser head along an endless path about the assembly; the dispenser head being moved about the assembly by resting at least one glass sheet on underlying movable supporting members, detaching the supporting members successively from the assembly to let the dispenser head through, and moving the supporting members back onto the assembly once the dispenser head has passed.

### CROSS REFERENCE TO RELATED APPLICATIONS

This application claims benefit under 35 U.S.C.

§119(a) of Italian Patent Application No. TO2011A 000151, filed Feb. 23, 2011, the entire contents of which are incorporated herein by reference.

The present invention relates to an insulating glass production method.

### BACKGROUND OF THE INVENTION

As is known, to produce insulating glass, a first and at least a second glass sheet are positioned facing on opposite sides of an inner spacer frame to form a hollow sheet-frame assembly, in which the spacer frame is normally positioned contacting outer peripheral portions of both glass sheets, and defines with the glass sheets a chamber for inert gas. Keeping the sheets in contact with the frame, a coating or bead of sealant is then deposited on the outer peripheral surface of the sheet-frame assembly to seal the chamber.

In known methods, the sealant is deposited using a sealing machine comprising a horizontal supporting and conveying surface, on which the assembly is placed substantially on edge, and which comprises two aligned powered linear conveyors spaced apart in the travelling direction of the assembly.

Between the two conveyors, the machine comprises a powered sealant dispenser head, which is movable vertically up and down, and rotates about a horizontal axis perpendicular to the vertical.

On machines such as these, the sealant is deposited on the front and rear edges of the sheet-frame assembly with the assembly projecting between the two conveyors and by moving the dispenser head vertically, and is deposited on the top and bottom edges by moving the sheet-frame assembly back and forth between the two conveyors, with the dispenser head in a fixed position. When depositing the sealant, the assembly is held by suction cup devices attached to one of the outer glass sheets.

In the case of insulating glass with one or more curved or sloping edge portions, the sealant is deposited on each of these by synchronizing the back and forth movement of the sheet-frame assembly with the vertical movement of the dispenser head.

Though widely used, the above sealing method has the drawback of having to move the sheet-frame assembly back and forth with respect to the dispenser head, which makes it difficult to keep the component parts of the assembly in the correct relative positions.

This is substantially due to a ‘leading’ portion and a ‘trailing’ portion of the moving assembly projecting as they travel along the path portion separating one conveyor from the other, and to the fact that, normally, not all the glass sheets are retained by the suction cup devices and/or rest on the bottom conveyors.

As a result, rejects not up to quality standard are common.

The sealing machines employed are also fairly complex and expensive, and must be checked continually to ensure both conveyors are not only perfectly controlled and synchronized with each other to move in time in both travelling directions of the assembly, but are also perfectly synchronized with the movement and rotation of the dispenser head. Any minor positioning errors or sharp stopping/starting of the conveyors, in fact, produce breaks and/or flaws in the sealant bead, thus impairing sealing of the inner chamber/s.

### SUMMARY OF THE INVENTION

It is an object of the present invention to provide an insulating glass production method designed to provide a simple, low-cost solution to the above drawbacks, and which, in particular, prevents relative movement of the glass sheets and frame when sealing the edges, regardless of the number of glass sheets of which the insulating glass is composed.

According to the present invention, there is provided a method of producing insulating glass, the method comprising the steps of forming an assembly comprising at least two facing glass sheets, and at least one inner spacer frame separating the glass sheets; keeping said assembly in a substantially vertical position; and depositing a bead of sealant on an outer peripheral edge of said assembly using a dispenser head; the method being characterized in that depositing said sealant comprises the steps of keeping said assembly stationary throughout the time taken to dispense said sealant; and moving said dispenser head along an endless path about said assembly; moving said dispenser head along said endless path comprising the steps of resting at least one of said glass sheets on movable supporting members underneath; detaching one or more of said supporting members successively from said assembly to let the dispenser head through; and moving at least some of said supporting members back onto said assembly once said dispenser head has passed.

The present invention also relates to a unit for producing insulating glass.

According to the present invention, there is provided a unit for producing insulating glass comprising an assembly, in turn comprising at least two facing glass sheets, at least one inner spacer frame separating said glass sheets, and a bead of sealant extending along an outer peripheral edge of said assembly; the unit comprising supporting means for supporting said assembly in a substantially vertical position; and a dispenser head for depositing said sealant and forming said bead; and the unit being characterized in that said supporting means support said assembly in a fixed position, and comprise a number of movable supporting members beneath at least one of said glass sheets; and powered actuating means for moving said supporting members to and from a supporting position supporting said assembly; the unit also comprising drive means for moving said dispenser head along an endless path about said assembly.

### BRIEF DESCRIPTION OF THE DRAWINGS

A number of non-limiting embodiments of the present invention will be described by way of example with reference to the accompanying drawings, in which:

FIG. 1 shows a view in perspective of a first preferred embodiment of a unit for producing insulating glass in accordance with the present invention;

FIGS. 2 and 3 show larger-scale side and front views respectively of the FIG. 1 unit;

FIG. 4 shows a view in perspective of a second preferred embodiment of a unit for producing insulating glass in accordance with the present invention;

FIGS. 5 and 6 show larger-scale side and front views respectively of the FIG. 4 unit;

FIG. 7 shows a view in perspective of a third preferred embodiment of a unit for producing insulating glass in accordance with the present invention.

### DETAILED DESCRIPTION OF THE INVENTION

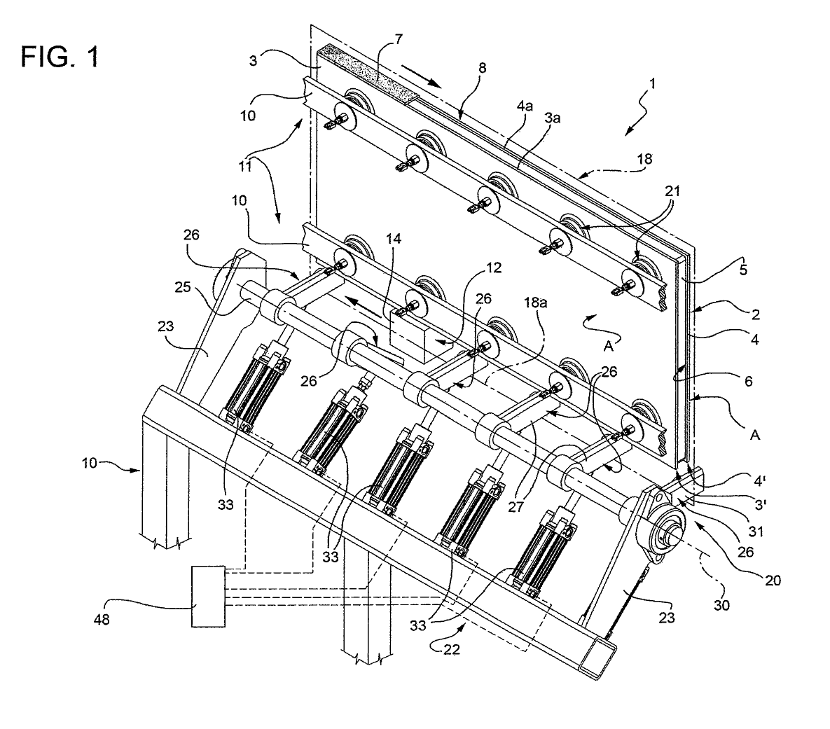

Number 1 in FIGS. 1 to 3 indicates as a whole a unit for producing insulating glass 2 comprising, in the example shown, two facing lateral glass sheets 3 and 4; a spacer frame 5 fitted between outer annular peripheral portions 3a and 4a of sheets 3 and 4, and defining with sheets 3 and 4 a chamber 6; and a continuous bead 7 of sealant deposited on the outer edge of the glass sheet-frame assembly 8 to seal chamber 6.

Unit 1 comprises a fixed frame 10; a retaining assembly 11 for holding the glass sheet-frame assembly 8 in a fixed vertical sealing position; and a sealing assembly 12 for forming continuous bead 7.

Sealing assembly 12 comprises a known dispenser head 14 (not described in detail) with a nozzle 15 for feeding sealant onto frame 5 and between peripheral portions 3a and 4a of the glass sheets; and a powered articulated control and support arm 16 for moving the dispenser head along an endless path 18 about assembly 8.

As shown in FIGS. 1 to 3, retaining assembly 11 comprises a supporting device 20 defining a bottom support for one or both of glass sheets 3 and 4; and a number of known suction cup devices 21 (not described in detail) arranged in a substantially vertical plane, and which engage sheet 3 to secure it in a fixed position with respect to frame 10 and on supporting device 20.

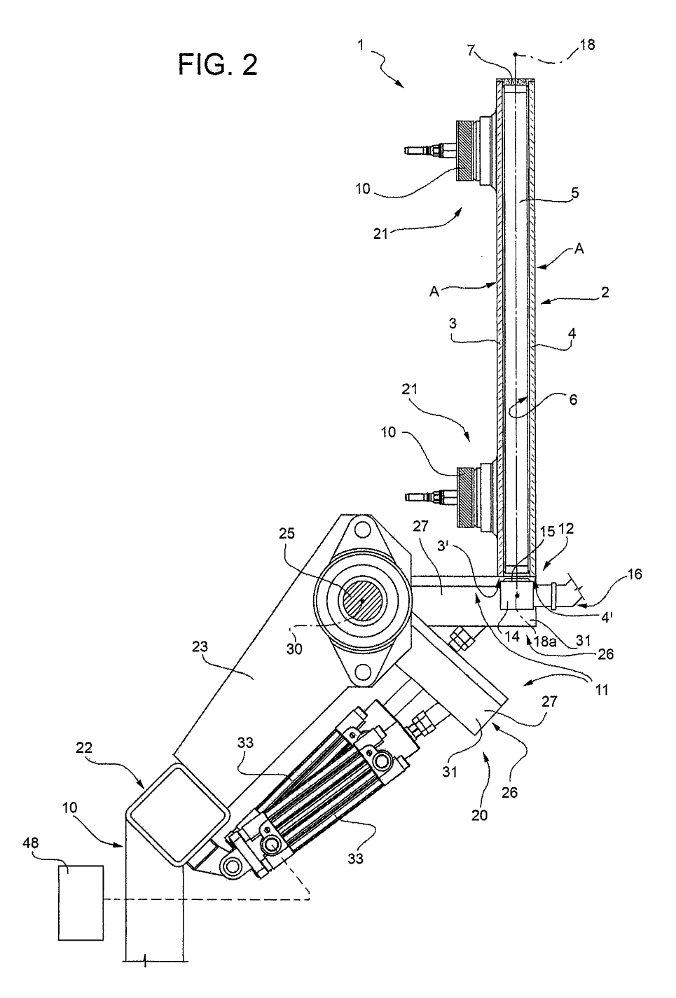

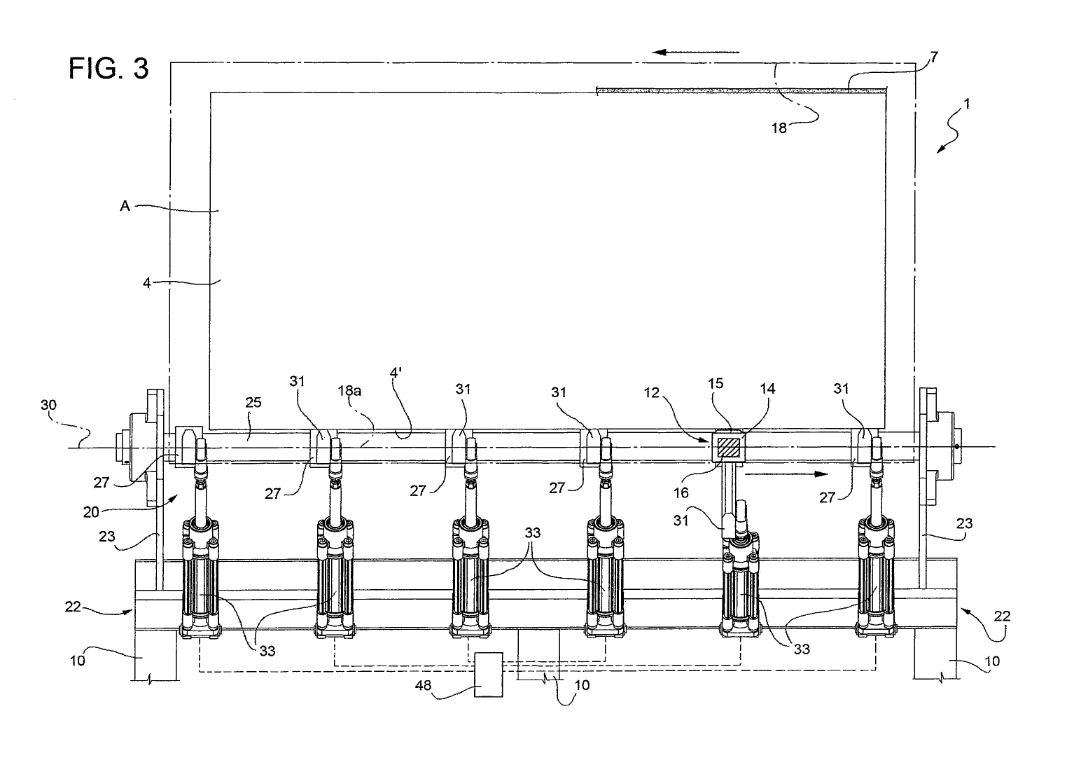

Device 20 comprises an inverted-fork-shaped fastening frame 22 connected integrally to frame 10, and the arms 23 of which are fitted with a horizontal shaft 25 parallel to the main surfaces A of glass sheets 3 and 4; and a number of straight supporting arms 26 spaced along and projecting perpendicularly from shaft 25. Each arm 26 has an end portion 27 hinged to shaft 25 to rotate about an axis 30 common to all of arms 26 and parallel to the bottom edges 3′, 4′ of sheets 3, 4; and an end portion 31 supporting assembly 8. Each arm 26 is operated, independently of the others and by a respective conveniently pneumatic linear actuator 33, to rotate about axis 30 between two limit positions on opposite sides of path 18: a raised supporting position, shown by the continuous line in FIGS. 2 and 3, in which portion 31 supports assembly 8; and a lowered standby position, shown in FIGS. 2 and 3, in which each arm 26 allows passage of head 14 as it moves along a portion 18a of path 18 parallel to edges 3′, 4′ of sheets 3,4.

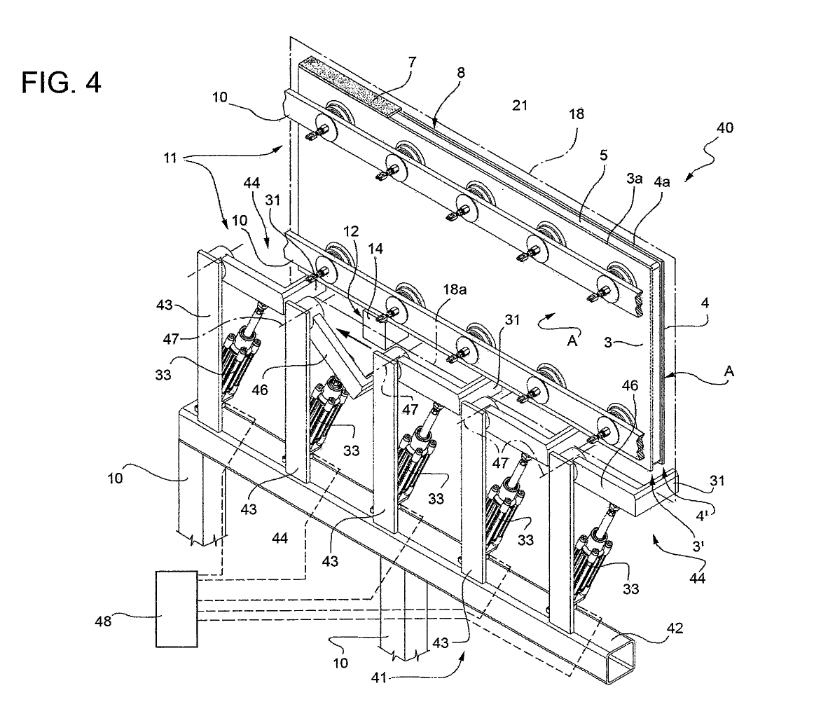

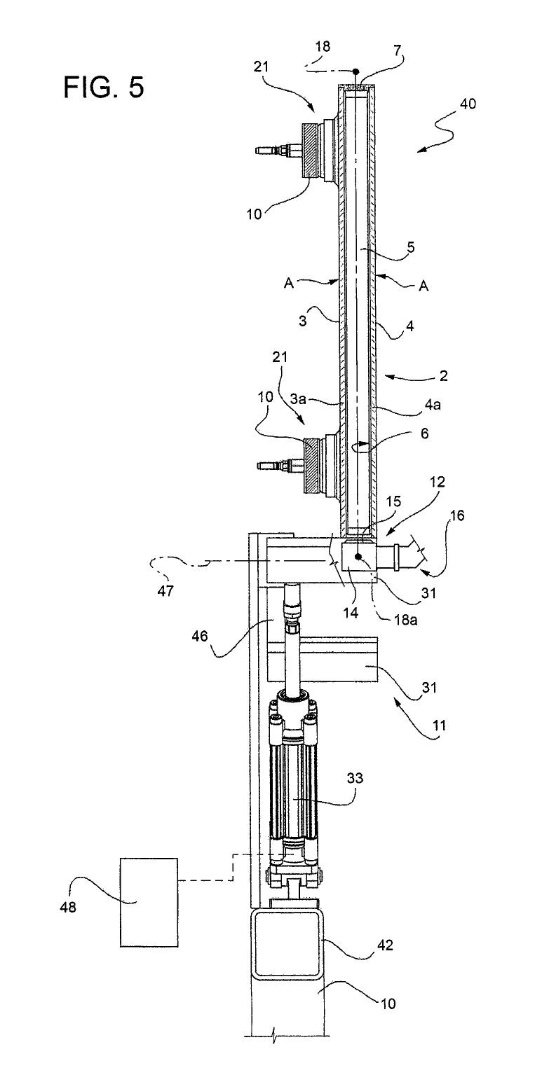

The FIGS. 4, 5 and 6 embodiment shows a unit 40, which differs slightly in design from unit 1, and the component parts of which are indicated, where possible, using the same reference numbers as for the corresponding parts of unit 1.

Unit 40 comprises a fastening frame 41, which differs from frame 22 by comprising a longitudinal member 42 parallel to edges 3′ and 4′ and connected integrally to fixed frame 10; and, for each actuator 33, a post 43 connected integrally to longitudinal member 42. In unit 40, each straight arm 26 of unit 1 is replaced with an arm 44, which differs from arm 26 by being L-shaped with one leg defined by supporting portion 31, and the other leg defined by a crank 46 hinged to post 43 and rotated by respective actuator 33 about a respective hinge axis 47, perpendicular to main surfaces A and parallel to the other axes 47, to move supporting portion 31 between said raised and lowered positions (FIGS. 4, 5 and 6).

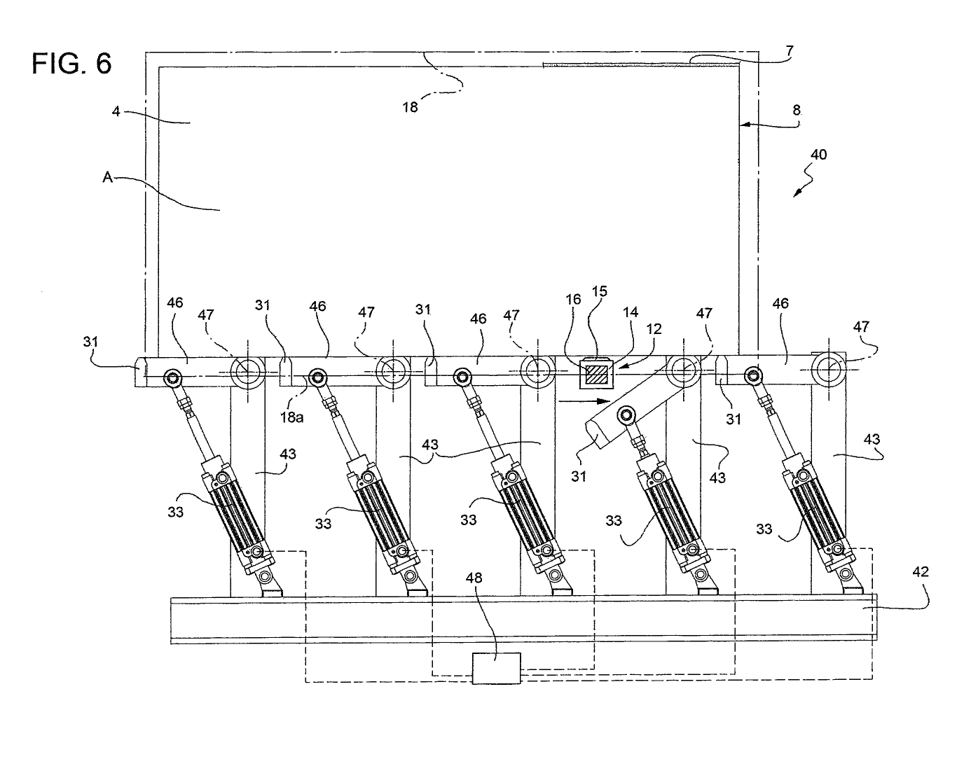

Actuators 33 of both units 1 and 40 are controlled by a central control unit 48, which synchronizes operation of actuators 33 with the movement of head 14 along path 18. More specifically, given the position of head 14 along path 18, central control unit 48 controls actuators 33 so that, as head 14 moves along path portion 18a and nears a supporting portion 31, this is moved from the raised supporting position to the lowered position (FIGS. 3 and 6) to let head 14 through, and is returned to the raised position once head 14 has passed. The sealant is thus deposited seamlessly, by keeping assembly 8 in a fixed position with respect to frame 10 of unit 1 throughout the sealing operation, i.e. until sealing is completed. That is, throughout the sealing operation, at least sheet 4 or both sheets 3 and 4 rest on a bottom support, which keeps them in a fixed position while still allowing transit of the sealant dispenser head.

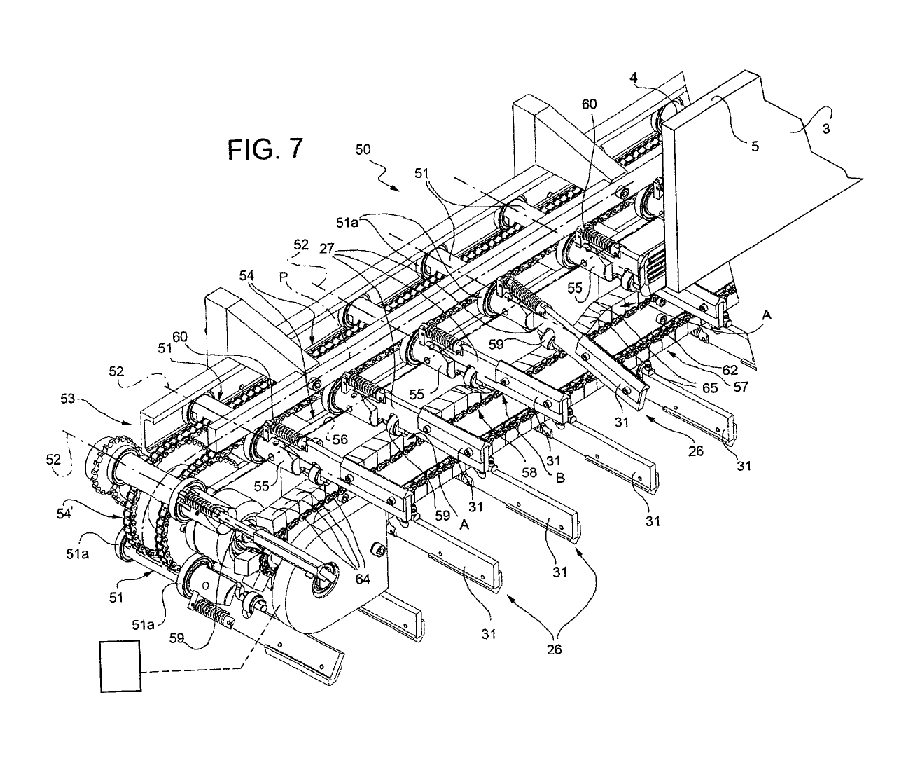

The FIG. 7 embodiment shows a unit 50, which differs slightly in design from unit 1, and the component parts of which are indicated, where possible, using the same reference numbers as for the corresponding parts of unit 1.

In unit 50, each arm 26 is fitted to a respective axle shaft 51 having a respective axis 52 and movable by an actuating and guide device 53 along an endless path P common to all of axle shafts 51. In the example shown, actuating and guide device 53 comprises two parallel, transversely spaced, endless rolling tracks 54, one for each wheel 51a of each axle shaft 51; and a powered double chain 54 for moving axle shafts 51 along path P.

Outwards of one of wheels 51a, each axle shaft 51 is fitted integrally with a respective fastening body 55, which projects from the axle shaft, and to which portion 27 of respective arm 26 is hinged by a respective hinge pin to rotate about an axis 56 perpendicular to axis 52 of axle shaft 51.

Arms 26 are rotated about respective axes 56 by a powered cam actuating device 57, which is activated independently of chain 54′, is synchronized with the movement of dispenser head 14, and comprises a cam 58 common to all of arms 26 and movable parallel to path P; and, for each arm 26, a roller 59 hinged to relative portion 27 to rotate about an axis perpendicular to axes 52 and 56. Each roller 59 is maintained contacting cam by a respective spring 60 compressed between a shoulder of relative portion 27 and a corresponding part of respective fastening body 55.

In the example shown, cam 58 comprises a further powered chain 62 parallel to and spaced transversely apart from chain 54′ so as to face portions 27; and a number of independent radial blocks fitted side by side to the outer periphery of chain 62, and arranged to form a succession A of blocks 64 of constant thickness, and a succession B of blocks 65 of varying thickness, as shown in FIG. 7.

The sealant is deposited by maintaining chain 54′ stationary, and operating cam 58 so that, as head 14 travels along path portion 18a, cam 58 and respective springs 60 move portions 31 successively from the raised supporting position to the lowered position to let head 14 through, and move portions 31 back into the raised position once head 14 has passed. Once the sealant is deposited, chain 54′ is operated to withdraw the finished insulating glass from head 14.

Unlike known methods, the sealing method described therefore eliminates any problems posed by errors in the relative position of the sheets and frame produced when moving the sheet-frame assembly, by virtue of keeping the assembly in a fixed position throughout the sealing operation, i.e. for as long as it takes to deposit the sealant.

Moreover, providing a support made of independent members—which can be detached successively from the sheet-frame assembly for only as long as it takes to let the dispenser head through, and are then restored to the original supporting position—is tantamount to supporting the sheet-frame assembly on a fixed supporting surface, on which, moreover, all the glass sheets are supported. That is, correctly timing detachment and reengagement of individual arms 26 prevents large leading and trailing portions of the assembly from projecting unsupported, especially when depositing the sealant, so the initial position of the sheets with respect to the frame remains unchanged throughout the sealing operation, thus ensuring consistent geometry and quality.

Finally, compared with known solutions, only moving dispenser head 14 in one direction along an endless path improves the quality of the sealant bead deposited, the geometric and sealing characteristics of which therefore remain constant along the whole of the peripheral edge of the sheet-frame assembly.

Clearly, changes may be made to units 1, 40 and 50 as described herein.

In particular, frames 10, 22 and 41, supporting arms 26 and 44, and the way in which arms 26 and 44 are operated may differ from those described by way of example. For example, supporting portions 31 may be operated using the same or a different cam device from the one described, or a connecting rod-crank device, or pneumatic or electric linear actuators for moving supporting positions 31 along straight paths perpendicular to edges 3′, 4′ of sheets 3, 4.

Units 1, 40 and 50 may obviously also be used for producing insulating glass with more than one chamber, i.e. comprising three or more glass sheets, and two or more inner spacer frames separating adjacent sheets.

1) A method of producing insulating glass, the method comprising the steps of forming an assembly comprising at least two facing glass sheets, and at least one inner spacer frame separating the glass sheets; keeping said assembly in a substantially vertical position; and depositing a bead of sealant on an outer peripheral edge of said assembly using a dispenser head; the method being characterized in that depositing said sealant comprises the steps of keeping said assembly stationary throughout the time taken to dispense said sealant; and moving said dispenser head along an endless path about said assembly; moving said dispenser head along said endless path comprising the steps of resting at least one of said glass sheets on movable supporting members underneath; detaching one or more of said supporting members successively from said assembly to let the dispenser head through; and moving at least some of said supporting members back onto said assembly once said dispenser head has passed.

2) A method as claimed in claim 1, characterized in that, when depositing said sealant, the other of said glass sheets is maintained in a fixed position by retaining means other than said supporting members.

3) A method as claimed in claim 1, characterized in that said supporting members are detached from said assembly by rotating about respective axes parallel to the major or main surfaces of said glass sheets.

4) A method as claimed in claim 1, characterized in that said supporting members are detached from said assembly by rotating about respective axes parallel to one another and perpendicular to the major or main surfaces of said glass sheets.

5) A method as claimed in claim 1, characterized by maintaining said supporting members contacting said assembly, and moving the supporting members parallel to themselves once said sealant is deposited.

6) A unit for producing insulating glass comprising an assembly, in turn comprising at least two facing glass sheets, at least one inner spacer frame separating said glass sheets, and a bead of sealant extending along an outer peripheral edge of said assembly; the unit comprising supporting means for supporting said assembly in a substantially vertical position; and a dispenser head for depositing said sealant and forming said bead; and the unit being characterized in that said supporting means support said assembly in a fixed position, and comprise a number of movable supporting members beneath at least one of said glass sheets; and powered actuating means for moving said supporting members to and from a supporting position supporting said assembly; the unit also comprising drive means for moving said dispenser head along an endless path about said assembly.

7) A unit as claimed in claim 6, characterized by also comprising retaining means for holding the other of said glass sheets in a fixed position.

8) A unit as claimed in claim 6, characterized in that each of said supporting members rotates, independently of the other supporting members and about a respective substantially horizontal axis parallel to the major or main surfaces of said glass sheets, between a raised supporting position and a lowered standby position on opposite sides of said endless path.

9) A unit as claimed in claim 6, characterized in that each of said supporting members rotates, independently of the other supporting members and about a respective axis of rotation perpendicular to the major or main surfaces of said glass sheets, between a raised supporting position and a lowered standby position on opposite sides of said endless path.

10) A unit as claimed in claim 6, characterized in that said powered actuating means comprise, for each of said supporting members, a respective linear actuator independent of the other linear actuators; and means for synchronizing said linear actuators with said drive means of said dispenser head.

11) A unit as claimed in claim 6, characterized in that said powered actuating means comprise cam means or connecting rod/crank means; and means for synchronizing said cam means with said drive means of said dispenser head.

12) A unit as claimed in claim 11, characterized in that said cam means comprise a cam common to all of said supporting members; each of said supporting members comprising a cam follower cooperating with the common said cam.
